(19) United States
(12) Patent Application Publication
(10) Pub. No.: US 2014/0267079 A1
(43) Pub. Date: Sep. 18, 2014

(54) TRANSACTION USER INTERFACE

(71) Applicant: Clinkle Corporation, (US)

(72) Inventors: Lucas Andrew Duplan, Orinda, CA (US); Robert G. Ryan, Atherton, CA (US)

(21) Appl. No.: 13/836,050

(22) Filed: Mar. 15, 2013

(51) Int. Cl. G06F 3/0488

(52) U.S. Cl. CPC G06F 3/04883
USPC 345/173

(57) ABSTRACT

Processing a touch input is disclosed. Information about a pending transaction is displayed. A touch input responsive to the displayed information is received. In the event the touch input indicates a first direction, the pending transaction is authorized. In the event the touch input indicates a second direction, the pending transaction is canceled.

### BACKGROUND OF THE INVENTION

Touch screen devices have enabled user interaction patterns that were not previously possible. Typically a button is displayed on a touch screen and a user selects the button to indicate a user input. However, users are prone to accidentally selecting an undesired button through unintended touches or inaccurately landing a finger outside the defined area of the intended target button. Therefore, there exists a better way provide a user input.

### BRIEF DESCRIPTION OF THE DRAWINGS

Various embodiments of the invention are disclosed in the following detailed description and the accompanying drawings.

FIG. 1A a block diagram illustrating an embodiment of a system for transferring information.

FIG. 1B is a block diagram illustrating an example of a computer.

FIGS. 2A-2D are diagrams illustrating an example data transmission.

FIG. 3 is a flowchart illustrating an embodiment of a process for providing an electronic invoice.

FIG. 4 is a flowchart illustrating an embodiment of a process for receiving an electronic invoice.

FIG. 5 is a flowchart illustrating an embodiment of a process for processing a transaction.

FIG. 6 is a flowchart illustrating an embodiment of a process for performing a user interface action.

FIG. 7A is a diagram illustrating an example user interface to input electronic payment details.

FIG. 7B is a diagram illustrating an example user interface when a touch input is associated with a downward direction.

FIG. 7C is a diagram illustrating an example user interface when a down direction touch input is associated with an action threshold amount of distance.

FIG. 7D is a diagram illustrating an example user interface when a touch input is associated with an upward direction.

FIG. 7E is a diagram illustrating an example user interface when an up direction touch input is associated with an action threshold amount of distance.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Processing a touch input is disclosed. In some embodiments, information about a pending transaction awaiting approval is displayed. For example, an electronic invoice is displayed for electronic payment approval. A touch input responsive to the displayed information is received. For example, a user may swipe a screen in one direction to authorize payment of the electronic invoice and the user may swipe in the opposite direction to cancel/reject payment of the electronic invoice. In the event the touch input indicates a first direction, the pending transaction is authorized. In the even the touch input indicates a second direction, the pending transaction is canceled.

FIG. 1A a block diagram illustrating an embodiment of a system for transferring information. Mobile device 102, terminal device 104, and server 106 are connected to network 110. Terminal device 104 is connected to sonic device 108. The connections shown in FIG. 1A may be wired and/or wireless connections. For example, network 110 includes a cellular data/internet network and mobile device 102 communicates with network 110 via a wireless cellular connection. In another example, terminal device 104 connects with network 110 via a WIFI connection and/or cellular connection. In another example, server 106 connects with network 110 via a wired connection. The connection between terminal device 104 and sonic device 108 may also be wired or wireless. For example, terminal device 104 and sonic device 108 are connected via a wired cable (e.g., an audio cable connected to headphone jack port of terminal device 104 or a data cable connected to data cable port of device 104). In another example, terminal device 104 and sonic device 108 are connected wirelessly (e.g., Bluetooth® wireless connection, WIFI connection, etc.). In some embodiments, terminal device 104 performs the function of sonic device 108 and sonic device 108 may be optional. In some embodiments, sonic device 108 includes a speaker that can be used to transmit a sonic signal and/or emit audio. For example, terminal device 104 may not include a speaker sufficiently powerful and/or movable to effectively transmit a sonic signal. In some embodiments, sonic device 108 includes a microphone that can be used to receive a sonic signal and/or detect audio.

In some embodiments, terminal device 104 may be used as a point of sale device and device 104 initiates a financial transaction. For example, a clerk using terminal device 104 inputs items to be purchased into terminal device 104 to generate an electronic invoice. In some embodiments, when mobile device 102 is within range of sonic device 108 and/or terminal device 104, mobile device 102 receives the electronic invoice via a microphone on mobile device 102, a sonic signal transmitted by sonic device 108 and/or terminal device mobile device 102. The mobile device may be able to authorize payment of the electronic by transmitting (e.g., using a sonic and/or radio frequency signal) an authorization to server 106 via network 110 and/or to terminal device 104 and/or sonic device 108 (e.g., terminal device 104 forwards the authorization to server 106). Server 106 processes the authorization to facilitate crediting and debiting of appropriate financial accounts to complete the financial transaction. In some embodiments, server 106 can be any computerized device that can be used to facilitate a transaction between terminal device 104 and mobile device 102, such as a computer run by a financial institution, credit card company, or other business or private entity. In some embodiments, server 106 executes instructions to facilitate the transmission of transaction information between terminal device 104 and mobile device 102.

In some embodiments, terminal device 104 and/or sonic device 108 is configured to transmit data in one-way audio/sonic wave broadcasts to the mobile device 102 using an ultrasonic data transfer scheme. In some embodiments, mobile device 102 is accordingly configured to receive the audio/sonic wave broadcasts and decode the received broadcasts to obtain the transmitted data. The described ultrasonic data transfer scheme may beneficially result in a secure transfer of data at an improved performance relative to various other near-field data transfer techniques. The data transfer scheme may also beneficially help reduce the effect of ambient noise received by the mobile device. It should be noted that although the transmitting of integers is described in many examples, other forms of data, for instance alphanumeric characters and floating point numbers, can be transmitted using the sonic data transfer scheme described herein.

In some embodiments, sonic device 108 and/or terminal device 104 broadcasts using a speaker a sonic signal (e.g., ultrasonic signal) that identifies terminal device 104. For example, the sonic signal encodes an identifier assigned a location, an account, and/or device of terminal device 104 and/or sonic device 108. For example, terminal device 104 and sonic device 108 are located in a retail environment and terminal device 104 broadcasts an identifier assigned to a point of sales device of the retail environment.

In some embodiments, a time delay is selected to encode data to be communicated. For example, a transmission signal includes a delay encoded signal that combines multiples copies of the same sonic (e.g., audio) signal, and each copy of the same sonic signal may be delayed relative to each other by a time delay amount that corresponds to a data to be communicated. In some embodiments, the transmission signal to be transmitted includes a plurality of frequency communication channels that can be used to transmit different data and each communication channel includes a delay encoded signal within the frequency band of the channel. In some embodiments, a receiver of the signal, such as a mobile device, receives the transmitted signal and for each frequency channel included in the signal, autocorrelates the signal in the channel to determine the delay encoded in the signal. The determined delays may be mapped to the data desired to be communicated.

In some embodiments, when mobile device 102 is within range of sonic device 108 and/or terminal device 104, mobile device 102 receives a sonic signal used to determine an identifier associated with sonic device 108 and/or terminal device 104. Mobile device 102 provides the identifier to server 106, and server 106 becomes aware that mobile device 102 is near terminal device 104 and/or sonic device 108. When a clerk using terminal device 104 inputs items to be purchased into terminal device 104 to generate an electronic invoice, the electronic invoice is provided to server 106 by terminal device 104. Because server 106 is aware that mobile device 102 is near terminal device 104, server 106 provides the electronic receipt to mobile device 102 via network 110. Mobile device 102 may be able to authorize payment of the electronic invoice by transmitting (e.g., using sonic and/or radio frequency signal) an authorization to server 106 via network 110 and/or to terminal device 104 and/or sonic device 108 (e.g., terminal device 104 forwards the authorization to server 106). Server 106 processes the authorization to facilitate crediting and debiting of appropriate financial accounts to complete the financial transaction.

In some embodiments, mobile device 102 includes an application such as an Apple iOS application or a Google Android operating system application. For example, a user of the application associates the user's account with the application. The user's account includes information on one or more of the user's financial accounts. For example, information regarding a user's credit card account, bank account, debit card account, and electronic payment account is stored in the user's account. A user may use the application to transfer funds between these financial accounts. Information such as current balance, transaction history, and credit limits may be provided by the application. A user may use the application to authorize payment from one or more of the user's financial accounts. In some embodiments, the application of mobile device 102 facilitates interaction with terminal device 104 and server 106. For example, the application receives the sonic signal and provides an identifier encoded in the signal to server 106. When an electronic invoice is ready for a user of the mobile device to review, server 106 sends the invoice to the application and the application displays the invoice for approval. The user may approve or cancel the electronic invoice using a user interface gesture. In another example, a user uses the application to initiate a payment to another user. The user may enter details about the payee, the amount, and a payment note/message and confirm or cancel the payment using a user interface gesture.

Mobile device 102, terminal device 104, and sonic device 108 may include one or more of the following components, a speaker, a microphone, an analog to digital signal converter, a digital to analog signal converter, a signal filter, a digital signal processor, a processor, a buffer, a signal adder, a signal generator, a transmitter, a receiver, a signal delayer, and a signal correlator. Examples of mobile device 102 include a smartphone, a tablet computer, a media player, a laptop, and another portable computer device. Examples of terminal device 104 includes a point of sale device, a desktop computer, a tablet computer, a smartphone, a laptop computer, a computer kiosk, and any other mobile device or computer device. Examples of server 106 include any computer, device, storage, database, and/or communication device that can send, receive, and/or process data. Examples of network 110 include one or more of the following: a direct or indirect physical communication connection, mobile communication network, a cellular network, Internet, intranet, Local Area Network, Wide Area Network, Storage Area Network, and any other form of connecting two or more systems, components, or storage devices together. In various embodiments, the components shown in FIG. 1A may exist in various combinations of hardware machines. For example, terminal device 104 and sonic device 108 may be included in the same device. Other communication paths may exist and the example of FIG. 1A has been simplified to illustrate the example clearly. For example, network components such as a router or a mesh network may be used to communicate via network 110. Although single instances of components have been shown to simplify the diagram, additional instances of any of the components shown in FIG. 1A may exist. For example, multiple mobile devices and multiple terminal devices with sonic devices may be communicating with multiple servers. Components not shown in FIG. 1A may also exist.

FIG. 1B is a block diagram illustrating an example of a computer. One or more components of computer 200 may be included in mobile device 102, terminal device 104, server 106, and/or sonic device 108. Although referred to as a “computer” herein, the computer of the embodiment of FIG. 1B can be a mobile device such as a mobile phone, a laptop computer, a tablet computer, and the like; or a non-mobile device such as a desktop computer, a server, a database, a cash register, a payment terminal, and the like.

The computer 200 includes processor 202 coupled to a chipset 204. The chipset 204 includes a memory controller hub 220 and an input/output (I/O) controller hub 222. A memory 206 and a graphics adapter 212 are coupled to the memory controller hub 220, and a display 218 is coupled to the graphics adapter 212. A storage device 208, input means 210, a microphone 214, at least one speaker 215, and network adapter 216 are coupled to the I/O controller hub 222. Other embodiments of the computer have different architectures. For example, the memory can be directly coupled to the processor in some embodiments.

The storage device 208 is a non-transitory computer-readable storage medium such as a hard drive, compact disk read-only memory (CD-ROM), DVD, solid-state memory device, or a magnetic tape drive. The storage device can also include multiple instances of the media, such as an array of hard drives or a magnetic tape changer in communication with a library of magnetic tapes. The memory 206 holds instructions and data used and executed by the processor 202. The instructions include processor-executable instructions configured to cause the processor to perform one or more of the functionalities described herein.

The input means 210 can be a keypad, a keyboard, a mouse, or any other means configured to receive inputs from a user of the computer 200. In some embodiments, the input means and the display are integrated into a single component, for instance in embodiments where the display is a touch-sensitive display configured to receive touch inputs from a user of the computer. In these embodiments, the input means can include a virtual board or other interface configured to receive touch inputs from the user on the display. For example, in embodiments where the computer is a mobile phone, the display of the phone may display a virtual keyboard, and a user can use the virtual keyboard to enter inputs to the computer. The graphics adapter 212 displays images and other information on the display device 218.

The microphone 214 is configured to receive audio signals as inputs and to communicate such inputs to the I/O controller hub. The at least one speaker 215 is configured to broadcast audio signals as outputs. The network adapter 216 is configured to communicatively couple the computer 200 to a network, such as a 3G/4G mobile phone network, a WIFI network, a local area network (LAN), the internet, or any other network, or another computer, such as a mobile device. Some embodiments of the computer have different and/or other components than those shown in FIG. 2.

The computer 200 is adapted to execute computer program modules for providing functionality described herein. As used herein, the term “module” refers to computer program instructions and other logic used to provide the specified functionality. Thus, a module can be implemented in hardware, firmware, and/or software. In one embodiment, program modules formed of executable computer program instructions are stored on the storage device 208, loaded into the memory 206, and executed by the processor 202.

FIGS. 2A-2D are diagrams illustrating an example data transmission. In some embodiments, data transmission between two devices (sender 2, which is equipped with a speaker, and a receiver 4, which is equipped with a microphone) that utilizes sonic/acoustic data transmission for device recognition and an out-of-band server 6 for primary data transfer. The out-of-band connection with the server 6 can be over a cellular wireless telephone connection or a WIFI connection. This data transmission protocol may include a setup phase, a transmit phase, a receive phase, and an acknowledge phase. For example, the data transmission protocol according to one embodiment can include a setup phase for a transmission protocol, a transmit phase where the first device (sender 2) transmits identification information to the second device (receiver 4), a reception phase where the second device (receiver 4) receives the identification information, and an acknowledgement phase. In some embodiments, sender 2 of FIGS. 2A-2D is included in terminal device 104 and/or sonic device 108 of FIG. 1A. In some embodiments, receiver 4 of FIGS. 2A-2D is included in mobile device 102 of FIG. 1A. In some embodiments, server 6 of FIGS. 2A-2D is included in server 106 of FIG. 1A.

Referring to FIG. 2A, during the setup phase, sender 2 and receiver 4 pull a transmission protocol from the server 6, as described in greater detail in the following sections. For example, one implementation includes one default transmission protocol, but it is not limited to a particular transmission protocol or a particular implementation of that protocol. During this phase, the sender 2 and receiver 4 agree to a transmission protocol that specifies transmit and receive algorithms and codes to be used. Accordingly, in FIG. 2A, the sender 2 and the receiver 4 both request parameters for the transmission/reception protocol in steps 61, 61a. In steps 62, 62a, the server 6 delivers a specific transmission/reception protocol to the sender 2 and the receiver 4. The specific transmission/reception protocol can include the instructions to be used for transmission, constants specifying a unique data encoding method, and other information for transmission and reception.

Referring to FIG. 2B, during the transmit phase, information can be exchanged. At the beginning of the transmit phase, the sender 2 sets the appropriate volume setting on its speaker so that it can transmit its identification to the receiver 4. The receiver, in step 71, enables listening so that it can detect the signal transmitted by the sender 2. As set forth above, the receiver 4 can use its microphone to receive the signal from the sender 2. In step 72, the sender 2 uploads the data to the server 6 so that the data can ultimately be delivered to the receiver 4. Next, in step 73, the sender 2 can receive a particular transmission code from the server 6 to be used for the exchange of information. The sender 2 then broadcasts an identification signal as specified by the transmission protocol in step 74. As previously noted in step 71, the receiver 4 listens through its microphone for valid identification signals from the sender 2. Accordingly, the receiver 4 can receive the signal broadcast by the sender 2.

As noted above, the sender 2 can use its speaker to broadcast the identification signals. In addition, the identification signals can be broadcast as within an ultrasonic frequency band. In addition, the receiver 4 can use its microphone to receive the signal from the sender 2. Accordingly, no special hardware is needed aside from that which is present in a typical smart phone or tablet computer.

Referring to FIG. 2C, during the receive phase, the receiver 4 can receive the signal from the sender 2. If the receiver 4 is in-range of the identification signal, the receiver 2 can decode the signal and then recover the appropriate data from the server 6. Accordingly, when the sender 2 broadcasts its code in step 81 of FIG. 8, the receiver 4 can receive the code in step 82 and decode it accordingly. Next, in step 83, after receiving the code from the sender 2, the receiver 4 can request data from the server 6. In step 84, the server 6 can deliver the data associated with the code to the receiver 4.

According to the steps set forth above, the sender 2 does not typically transmit sensitive data directly to the receiver 4. Instead, the short-range wireless communication is used between the sender 2 and receiver 4 only to properly identify the sender 2 to the receiver 4. The exchange of any sensitive information, such as financial transaction information, can be securely transmitted from the sender 2 to the server 6 and then from the server 6 to the receiver 4.

Referring to FIG. 2D, during the acknowledgement phase, the receiver 4 can acknowledge that it has received the relevant data. Typically, the receiver 4 uses an out-of-band channel for the acknowledgement phase (the channel is different from the channel on which the sender 2 broadcasts its identification information). Accordingly, after primary data reception is complete, the receiver 4 initiates the acknowledgement phase, during which the receiver 4 sends an acknowledgement signal to the server 6 during step 91. The server 6 then sends the receiver acknowledgement to the sender 2 in step 92. In step 93, the sender 2 may stop or continue broadcasting its identification signal, and in step 94, the receiver 4 may stop or continue listening for the identification signal. In some embodiments, the sender 2 will continue to broadcast its code until receiving the acknowledgement signal from the server 2, at which point all communication ceases. In other embodiments, the sender 2 will continue to broadcast its code even after receiving the acknowledgement signal from the server 2.

Referring again to the setup phase shown in FIG. 2A, the sender 2 and receiver 4 synchronize on the allowable codes to be used for the communication. In addition, the sender 2 and receiver 4 agree upon the corresponding echo delays and allowable codes by point-to-point communication with the server 6. In one embodiment, the default transmission protocol transmits an integer code using echo delay encoding of ultrasonic waves in the 19 kHz-21 kHz band. At the time of transmission, the sender 2 generates a random noise profile stream and emits this profile through a band-pass filter permitting 19 kHz-21 kHz. After a time delay d=c+1 milliseconds have elapsed, where c is a store specific encoding delay, the same noise profile is added to the output. Simultaneously, the receiver 4 buffers up to 500 milliseconds of microphone input sampled at 44.1 kHz and computes the peaks of the convolution of the signal with itself. The time delay d′ of the first peak after 0 ms is regarded as the received code. To expand beyond the simple 1-to-1 mapping of delay to sender identification a tree-based algorithm may be implemented where each one of x unique signals may specify a direction through a tree of depth y to account for (x)̂y possible unique sender identifiers. To account for false positives and random similarities in the noise profile, in one embodiment, the receiver 4 must receive the same code in a set number of consecutive buffer intervals before accepting the transmitted code as reliable.

The transmission protocol can also require the sender 2 and receiver 4 to have out-of-band access to an external server 6, as shown in FIGS. 2A-2D. In other embodiments, the receiver 4 need not have communication with the server 6 out-of-band during the time of the transaction with the server 6. For example, if the receiver 4 has already received the transmission protocol to be used for communication and the sender 2 also has the same protocol information, it may be possible for the receiver 4 to be used even if it does not have communication with the server 6 at the point of the transaction (such as at the point of sale). For instance, if the receiver 4 is a wireless smart phone, but it is in a location where there is not cellular service or WIFI service (both of which can typically be used for communication with the server 6), it may still be possible to perform the transaction. In one such embodiment, the sender 2 will broadcast its identification code and the receiver 4 will listen for the code, as described above. In this embodiment, instead of having the receiver 4 download data for the transaction from the server 6, the receiver 4 may send and receive transaction information directly from the sender 2 using the agreed upon protocol over the medium utilized for device recognition. The sender 2 can thereafter relay this identification and transaction information to the server 6, and this can provide authorization for the transaction. For instance, the receiver 4 may be able to provide authorization for a transaction to the server 6 through the sender 2.

In some embodiments, a method for payments from one wireless device to another is provided. For example, the sender will upload payment data to a server using an out-of-band connection while broadcasting an identification signal through a built-in speaker following an acoustic protocol over the 19 kHz-21 kHz band. As a specific example for a point-of-sale embodiment, the sending device may be used by a merchant. The sender can send to the server the amount of money that the user of the receiving device must pay for the transaction. For instance, if a good at the point of sale costs $7.55, the sender can send this amount to the server. In tandem, the receiver will detect the identification signal via its microphone, decode this signal, and request the transaction information from the server. After processing the transaction information, the receiver will send an acknowledgement signal through the server to the sender, at which point the transaction is complete. For instance, the receiver listens for the identification signal from the sender and then decodes this signal. After decoding it, the receiver sends a signal to the server to indicate that the receiver is within range of the specific sender for which the receiver has decoded the identification signal. The server may then route the sale cost information (the transaction information) to the receiver. In the specific example set forth above, for instance, the receiver will receive information indicating that the purchase will cost $7.55. The user of the receiver can acknowledge that it is OK to pay this amount to the merchant, and this will result in the receiver sending an acknowledgement signal through the server to the sender. Upon receiving this acknowledgement signal, the sender knows that the receiver has approved of the transaction and the transaction is complete. Echo delay encoding, using the delay between repetitive signals to encode identification information, may be used. Other protocols may be used. In some cases, this may result in a simple method for the user of the receiver to pay for goods at the point of sale without using cash or a credit card.

In another embodiment for payment between two wireless devices, sender uploads payment data to a server using an out-of-band connection while broadcasting an identification signal through a built in speaker following an acoustic protocol over the 19 kHz-21 kHz band. If no connection to the server can be established, communication may occur solely over the acoustic medium. In the case that connection to a server can be established, the receiver will detect the identification signal via microphone, decode it, and request the payment information from the server. After processing the payment information, the receiver will send an acknowledgement signal through the server via an out-of-band connection or directly to the sender via acoustics, at which point the transaction is complete. In some embodiments, several encoding protocols for acoustic data transfer may be used, such as utilization of a tree structure for more expansive mapping, although the primary is echo delay encoding using the delay between repetitive signals to encode identification information in a 1-1 mapping.

In some embodiments, a sender will upload data to a server using an out-of-band connection while broadcasting an identification signal over one of several mediums, including acoustic and radio (e.g., Ultrasound, Bluetooth, NFC, infrared, etc.). In addition, if no connection to the server can be established, communication may occur directly over one of the aforementioned mediums. In the case that connection to a server can be established, the receiver will detect the identification signal, decode it, and request the information from the server. After receipt of information, the receiver will send an acknowledgement signal through the server via an out-of-band connection or directly to the sender via one of the primary communication mediums, at which point the transaction is complete. In some embodiments, several encoding protocols for data transfer, with the default being echo delay encoding using the delay between repetitive signals to encode identification information in a 1-1 mapping or a tree structure providing for more expansive mapping, may be used. In some embodiments, other denser protocols when utilizing the acoustic or radio mediums may be utilized.

In some embodiments, point-to-point communication between two devices can be established that does not require direct device-to-device contact. Instead, speaker of the sender and the microphone of the receiver may enable communication between the two devices over a greater distance, such as, for example, 5 meters. In some embodiments, examples described herein do not require special hardware that is not typically present in a smart phone. For example, most smart phones are able to transmit and receive ultrasound signals. In some embodiments, enable real-time communication between two devices is enabled without requiring a lengthy binding process, which can be required for communication according to certain protocols.

FIG. 3 is a flowchart illustrating an embodiment of a process for providing an electronic invoice. At least a portion of the process of FIG. 3 may be implemented on terminal device 104 and/or sonic device 108 of FIG. 1A.

At 302, an identifying signal is transmitted. In some embodiments, the identifying signal is an ultrasonic signal transmitted using a speaker. In some embodiments, a device such as terminal device 104 and/or sonic device 108 of FIG. 1A uses its speaker to transmit the identifying signal. In some embodiments, the identifying signal encodes an identifier assigned a location, an account, and/or a device of a terminal device and/or a sonic device. For example, terminal device 104 and sonic device 108 of FIG. 1A are located in a retail environment and terminal device 104 generates a signal (e.g., encoding an identifier assigned to a point of sales device of the retail environment) that is transferred to sonic device 104 to be broadcasted by a speaker of sonic device 104. In some embodiments, the transmitted signal may be received by a device such as mobile device 102 of FIG. 1A to determine an identifier encoded in the signal. Using the identifier, it may be determined that the device that received signal is within the physical vicinity of a terminal device initiating a financial transaction. For example, the identifying signal is transmitted to identify that a mobile device that can be used to conduct a transaction (e.g., authorize a financial payment) is near a point of sale terminal. In some embodiments, the mobile device provides the determined identifier encoded in the signal to a server such as server 106 of FIG. 1A to allow the server to track that the mobile device is located near the terminal device of the identifier and is able to conduct a transaction with the terminal device.

At 304, an electronic invoice is provided. In some embodiments, the electronic invoice is provided via a network such network 110 of FIG. 1A. In some embodiments, providing the electronic invoice includes sending an indication of an amount desired to be received. The electronic invoice may specify one or more items to be purchased, a total amount, and/or an identifier of a merchant. In some embodiments, the electronic invoice is sent to a server that facilitates an electronic financial transaction. For example, when a clerk using a terminal device such as device 104 of FIG. 1A inputs items to be purchased into the terminal device to generate an electronic invoice, the electronic invoice is provided to server such as server 106 by the terminal device. In some embodiments, a version of the provided electronic invoice may be forwarded by the server (e.g., the server that received the identifier provided by a mobile device receiving the identifying signal transmitted at 302) to a mobile device (e.g., device 102 of FIG. 1A) such as a mobile device that received the identifying signal transmitted at 302.

At 306, a response to the electronic invoice is received. In some embodiments, the response is provided via a network such network 110 of FIG. 1A. In some embodiments, the response includes an authorization that confirms payment of the electronic invoice. In some embodiments, the response indicates that the electronic invoice has not been authorized. For example, a user rejects payment of the invoice and/or a user does not have sufficient funds to pay the invoice. In some embodiments, the response includes an identifier of a mobile device used to provide the payment of the electronic invoice. For example, a mobile device that received a forwarded version of the electronic invoice sent at 304 authorizes payment of the electronic invoice and the response from the mobile device is provided to a server that processes the authorization. The server may facilitate crediting and debiting of appropriate financial accounts to complete the financial settling the electronic invoice and provide the response received at 306.

FIG. 4 is a flowchart illustrating an embodiment of a process for receiving an electronic invoice. At least a portion of the process of FIG. 4 may be implemented on mobile device 102 of FIG. 1A.

At 402, an identifying signal is received. In some embodiments, the identifying signal includes the identifying signal transmitted at 302 of FIG. 3. In some embodiments, the received signal is an ultrasonic signal received using a microphone. In some embodiments, a mobile device such as mobile device 102 of FIG. 1A uses its microphone to receive the identifying signal. In some embodiments, the identifying signal encodes an identifier assigned a location, an account, and/or a device of a terminal device and/or a sonic device. For example, terminal device 104 and sonic device 108 of FIG. 1A are located in a retail environment and terminal device 104 generates a signal (e.g., encoding an identifier assigned to a point of sales device of the retail environment) to be broadcasted by a speaker of sonic device 104 and received by a mobile device within the retail environment.

At 404, an identifier encoded in the received signal is determined and provided. In some embodiments, determining the identifier includes processing the received signal to determine the identifier. In some embodiments, the determined identifier is provided to a server such as server 106 of FIG. 1A to allow the server to track that the provider is located near the terminal device associated with the identifier. In some embodiments, the identifier is provided via a network such network 110 of FIG. 1A. In some embodiments, the identifier encoded in the received signal is provided together with an identifier of a device (e.g., mobile device) providing the identifiers.

At 406, an electronic invoice is received. In some embodiments, the electronic invoice is a version of the electronic invoice provided at 304 of FIG. 3. For example, the electronic invoice may be received from the server that received the identifier provided at 404. The electronic invoice may specify one or more items to be purchased, a total amount, and/or an identifier of a sender (e.g., merchant).

At 408, a response to the electronic invoice is provided. In some embodiments, in response to the response provided at 408, the response at 306 of FIG. 3 was provided. In some embodiments, the response indicates whether to authorize payment of the invoice from an electronic account associated with a device that received the response. In some embodiments, the response indicates that the electronic invoice was sent to a device that is not a part of a transaction. For example, the electronic invoice may be sent to all mobile devices near a point of sale terminal and mobile devices not part of the transaction to be conducted may indicate that it does not desire to be a part of the transaction. In some embodiments, the response includes an authorization of payment, and a server receiving the authorization may facilitate crediting and debiting of appropriate financial accounts to complete the financial settling the electronic invoice and provide the response received at 306 of FIG. 3.

FIG. 5 is a flowchart illustrating an embodiment of a process for processing a transaction. At least a portion of the process of FIG. 5 may be implemented on server 106 of FIG. 1A.

At 502, an identifier is received. In some embodiments, the identifier includes the identifier sent at 404 of FIG. 4. In some embodiments, the received identifier identifies a location, an account, and/or a device of a terminal device (e.g., device 104 of FIG. 1A) and/or a sonic device (e.g., device 108 of FIG. 1A). For example, a unique identifier is assigned to each point of sale terminal that has account with a payment settling server such as server 106 of FIG. 1A and the received identifier is one of these unique identifiers. In some embodiments, the received identifier is associated with an account of a user of a device that provided the identifier. Using the identifier, it may be determined that the device that received signal is within the physical vicinity of a terminal device facilitating a financial transaction. For example, the received identifier is provided with a user/account identifier, and a database keeps track of which user accounts are within range of a point of sale terminal that has been assigned the received identifier. When an invoice is desired to be sent by the point of sale terminal to a device within range of the terminal, the invoice may be provided to one or more devices of the user accounts known to be within range (e.g., determined using the database) of the terminal.

At 504, an electronic invoice is received. In some embodiments, the received electronic invoice includes the invoice provided at 304 of FIG. 3. The electronic invoice may specify one or more items (e.g., goods and services) to be purchased, a total amount, and/or an identifier (e.g., identifier received at 502) of a merchant. For example, when a clerk using a terminal device such as device 104 of FIG. 1A inputs items to be purchased into the terminal device to generate an electronic invoice, the electronic invoice is provided to a server such as server 106 by the terminal device.

At 506, the received electronic invoice is forwarded. In some embodiments, forwarding the electronic invoice includes providing a version of at least a portion of the data included in the received electronic invoice to one or more (e.g., all) of mobile devices that provided the identifier received at 502. For example, an identifier associated with a merchant of the received electronic invoice is used to search a database to locate user accounts/devices indicated to be receiving an identifying signal of the identifier. A version of at least a portion of the data included in the received electronic invoice may be provided to one or more of these user accounts/devices. In some embodiments, the forwarded electronic invoice includes the electronic invoices received at 406 of FIG. 4.

In some embodiments, forwarding the electronic invoice includes providing a version of at least a portion of the data included in the received electronic invoice to one or more of mobile devices that provided the identifier received at 502 and also provided an identification that the mobile device desires to receive an electronic invoice. For example, when a mobile device provides the identifier at 502, an identification of a merchant associated with identifier is provided to the mobile device. The mobile device is then able to indicate (e.g., via a selection of a user interface object, a touch input gesture, dragging a user interface object, shaking the mobile device, orientating the mobile device in a certain position, moving the mobile device in a certain motion, etc.) that a user of the mobile device is ready to review and respond to an electronic invoice from the identified merchant, and the electronic invoice is only provided to those mobile devices that provided the indication.

At 508, a response to the electronic invoice is received. In some embodiments, the response includes the response provided at 408 of FIG. 8. For example, the response indicates whether to authorize payment of the invoice from an electronic account associated with a device that received the response. In some embodiments, in the event the response authorizes payment of the invoice, crediting and debiting of appropriate financial accounts (e.g., credit account of a merchant logged on to a terminal device and debit from a customer logged on to a mobile device) to complete the financial settling the electronic invoice are facilitated. In some embodiments, if a response indicating an approval to authorize the payment is received from a plurality of devices, only the first received approval is accepted and processed as an authorization. In some embodiments, if a response indicating an approval to authorize the payment is received, the electronic invoice provided to any other mobile device at 506 is cancelled and/or refracted. For example, server 106 of FIG. 1A sends a message via network 110 to all mobile devices that did not provide the accepted authorization (e.g., mobile device 102 of FIG. 1A) to cancel/retract the provided request.

At 510, a result of processing the response is provided. In some embodiments, providing the result includes providing the response received at 306 of FIG. 3. In some embodiments, the result includes a confirmation of payment of the electronic invoice. In some embodiments, the result indicates that the electronic invoice has not been authorized. For example, a rejection of the invoice is received at 508 and/or it is determined that a user does not have sufficient funds to pay the invoice. In some embodiments, the result includes an identifier of a mobile device and/or user account used to provide the payment of the electronic invoice.

FIG. 6 is a flowchart illustrating an embodiment of a process for performing a user interface action. The process of FIG. 6 may be at least in part implemented on terminal device 104 and/or mobile device 102 of FIG. 1A. For example, an application of terminal device 104 and/or mobile device 102 implements at least a portion of the process of FIG. 6. In some embodiments, the process of FIG. 6 is included in 408 of FIG. 4.

At 602, information about a pending transaction is displayed. The pending transaction may be any type of pending transfer/approval. For example, the pending transaction may be associated with a financial transaction, a boarding pass (e.g., checking in for a flight), a key (e.g., opening a door, accessing data), an invite (e.g., approving an invite), a coupon (e.g., redeeming a coupon), etc. In some embodiments, the pending transaction includes a financial transaction of an electronic invoice received at 406 of FIG. 4 that is awaiting approval. In some embodiments, the displayed information include an identifier of a payee/merchant, a listing of one or more items/services to be purchased, a price of one or more items/services, and a total amount. In some embodiments, the pending transaction includes an electronic payment to a user specified payee. FIG. 7A is a diagram illustrating an example user interface to input electronic payment details. Visual paper object 700 includes input area 702 to input an identifier of a payee, input area 704 to input an amount to be paid and input area 706 to input a message to a payee. In some embodiments, the displayed information is visually associated together as a single object. For example, the displayed information is displayed on a visual representation of a paper receipt. In some embodiments, displaying the information includes animating an object to simulate the object visually entering a display screen. For example, a visual representation of a paper (e.g., object 700 of FIG. 7) moves into a display screen from an edge of the screen. In some embodiments, which edge of the screen the object enters the screen signifies an information about the object. For example, a paper object enters a display screen from a bottom edge of the screen to signify an incoming request for payment.

At 604, a touch input responsive to the displayed information is received. In some embodiments, a display screen used to display the information is a touch input screen. For example, a display screen of terminal device 104 and/or mobile device 102 can be touched to provide a user input. For example, a user may touch, drag, swipe, and gesture by contacting a surface of the display screen using a touch input instrument (e.g., a finger, a stylus, etc.). In some embodiments, the touch input includes a series of one or more touch input location coordinates over a period of time. For example, when a user drags a finger over a screen the drag is captured as successive touch input points that move over time. In some embodiments, the touch input includes a swipe and/or a drag of a touch input instrument on a touch input surface. In some embodiments, the touch input is associated with a location coordinate, a direction, a distance, and/or time value.

At 606, an indication indicated by the touch input is determined. In some embodiments, the received touch input is analyzed to determine a direction and a distance of the touch input. For example, the touch input includes dragging/swiping of a touch input instrument and a direction and a distance of the input are determined. In some embodiments, determining the direction includes determining a direction and a distance of a single dimensional axis. For example, the touch input includes a horizontal and a vertical directional components and the vertical component of the movement is isolated to determine the vertical direction and vertical distance of the movement.

In some embodiments, determining the indication includes determining that touch input is associated with dragging a displayed object. For example, an electronic invoice or a visual paper object such as object 700 of FIG. 7A is indicated as being dragged (e.g., a touch input begins at a location on a screen where the object has been displayed). In some embodiments, the direction an object is dragged indicates a desired action associated with the object. For example, if the object is dragged in the direction towards the top of the screen, it indicates that the user desires to approve the pending transaction and if the object is dragged in the direction towards the bottom of the screen, it indicates that the user desires to cancel the pending transaction. In some embodiments, after the indication has been registered, the object disappears off the screen in the direction the object was dragged. For example, if the object was dragged towards the top of the screen to indicate acceptance of the financial transaction, the object disappears away from the screen into the top of the screen and if the object was dragged towards the bottom of the screen to indicate rejection/cancellation of the financial transaction, the object disappears away from the screen into the bottom of the screen.

In some embodiments, the object cannot be dragged in at least one direction (e.g., cannot be dragged up to be accepted) if the financial transaction of the object is not ready to be submitted. For example, if the payee field (e.g., 702 of FIG. 7A) of an object has not been completed, the object cannot be dragged upwards to complete the financial transaction and an error message is provided that the payee field must be completed. In another example, when a field such as a total amount field is selected, an input keyboard is displayed. While the keyboard is displayed, a financial transaction object cannot be dragged upwards to complete the financial transaction.

In some embodiments, determining the indication includes determining a distance associated with the touch input. For example, a distance a touch input instrument has been dragged on a touch input surface is determined. The distance may be a distance relative to an initial point of contact on a touch input surface. In an alternative embodiment, the distance is a distance a touch input instrument has traveled in contact with a touch input surface. The distance maybe a single dimensional axis distance. In some embodiments, a different indication is provided based at least in part on the determined distance. For example, a touch input instrument must be dragged at least a threshold distance in order to approve or cancel the pending transaction. In some embodiments, when a touch input instrument is placed on a touch input surface and dragged in a direction, a description of an indication indicated by the touch input is displayed. When the distance of the input meets a threshold distance (e.g., threshold distance from initial point of touch input contact), an indication may be provided that if the touch input instrument is released from the touch input surface, the indicated action will be performed. If the distance of the drag does not meet the threshold distance before the touch input instrument is released from a touch input surface, the indication action may not be registered/performed and an object such as object 700 of FIG. 7A returns to a resting position as shown in FIG. 7A.

FIG. 7B is a diagram illustrating an example user interface when a touch input is associated with a downward direction. FIG. 7B shows object 700 after it has been selected by a touch input instrument that has contacted a surface of a display screen and dragged downward. In some embodiments, cancel indication 710 is displayed when touch input instrument has been dragged a first threshold amount of distance. In some embodiments, cancel indication 710 is displayed when it is detected that the touch input instrument has been dragged in a downward direction. In some embodiments, cancel indication 710 gradually appears from top of the screen in proportion to the distance the touch input instrument has traveled in contact with a touch input surface. For example, more of cancel indication 710 is displayed if the touch input instrument travels further in a downward direction and less of the cancel indication 710 is displayed if the touch input instrument travels further in an upward direction. After cancel indication 710 is fully visible, it may stay on top of the screen even if the touch input instrument travels further in a downward direction but may disappear upwards relative to the distance the touch input instrument travels in an upward direction.

In some embodiments, when touch input instrument has been dragged at least an action threshold amount of distance (e.g., threshold distance from initial point of touch input contact), an action indication is indicated. If the touch input instrument is released when the action indication is indicated, an action of the indication may be performed. If the touch input instrument is later moved to be below the action threshold, the action indication may be removed. If the touch input instrument is released when the action indication is not indicated, the cancel action may not be performed and object 710 may return to the state shown in FIG. 7A.

FIG. 7C is a diagram illustrating an example user interface when a down direction touch input is associated with an action threshold amount of distance. FIG. 7C shows that when a touch input instrument has been dragged in a down direction at least an action threshold amount of distance (e.g., threshold distance from initial point of contact), icon 712 of cancel indication 710 changes color from a gray color to a red color. This indicates if the touch input instrument is released, the financial transaction of object 700 will be canceled. If the touch input instrument is later dragged to a position that is less than an action threshold amount of distance (e.g., vertical distance between initial touch input coordinate and current touch input coordinate is less than the action threshold amount of distance), icon 712 may change back to gray color.

FIG. 7D is a diagram illustrating an example user interface when a touch input is associated with an upward direction. FIG. 7D shows object 700 after it has been selected by a touch input instrument that has contacted a surface of a display screen and moved (e.g., dragged) upward while still contacting the display screen. In some embodiments, approve indication 720 is displayed when touch input instrument has been dragged a first threshold amount of distance. In some embodiments, approve indication 720 is displayed when it is detected that the touch input instrument has been dragged in an upward direction. In some embodiments, approve indication 720 gradually appears from the bottom of the screen in proportion to the distance the touch input instrument has traveled on the touch input surface. For example, more of approve indication 720 is displayed if the touch input instrument travels further in an upward direction and less of approve indication 720 is displayed if the touch input instrument travels further in a downward direction. After approve indication 720 is fully visible, it may stay on bottom of the screen even if the touch input instrument travels further in an upward direction but may disappear downwards relative to the distance the touch input instrument travels in a downward direction.

In some embodiments, when touch input instrument has been dragged at least an action threshold amount of distance (e.g., threshold distance from initial point of touch input contact), an action indication is indicated. If the touch input instrument is released when the action indication is indicated, an action of the indication may be performed. If the touch input instrument is later moved to be below the action threshold, the action indication may be removed. If the touch input instrument is released when the action indication is not indicated, the cancel action may not be performed and object 710 may return to the state shown in FIG. 7A.

FIG. 7E is a diagram illustrating an example user interface when an up direction touch input is associated with an action threshold amount of distance. FIG. 7E shows that when a touch input instrument has been dragged in an up direction at least an action threshold amount of distance (e.g., threshold distance from initial point of touch input contact), icon 722 of approve indication 720 changes color from a gray color to a green color. This indicates if the touch input instrument is released, the financial transaction of object 700 will be approved. If the touch input instrument is later dragged to a position that is less than an action threshold amount of distance (e.g., vertical distance between initial touch input coordinate and current touch input coordinate is less than the action threshold amount of distance), icon 722 may change back to gray color.

At 608, an indicated action is performed, if applicable. In some embodiments, if the indication determined at 606 indicates an approval action, the pending transaction is executed. For example, a response that the electronic invoice is approved is provided in 408 of FIG. 4 and the electronic invoice is processed for payment. In another example, funds are transferred to the desired payee of an indicated amount. In some embodiments, if the indication determined at 606 indicates a cancel/rejection action, the pending transaction is canceled. For example, a response that the electronic invoice is canceled/rejected is provided in 408 of FIG. 4 and the electronic invoice is not processed for payment. In another example, electronic payment input user interface is no longer displayed.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for processing a touch input, comprising:
a display configured to display information about a pending transaction;
a touch input surface coupled with the display and configured to receive a touch input responsive to the displayed information; and
a processor configured to, in the event the touch input indicates a first direction, authorize the pending transaction, and in the event the touch input indicates a second direction, cancel the pending transaction.

2. The system of claim 1, wherein the information about the pending transaction includes an electronic invoice.

3. The system of claim 1, wherein the information about the pending transaction includes a listing of one or more items to be purchased.

4. The system of claim 1, wherein the pending transaction includes a pending electronic financial payment.

5. The system of claim 1, wherein displaying the information includes displaying the information as an object that can be visually moved.

6. The system of claim 1, wherein the touch input includes a swipe.

7. The system of claim 1, wherein the touch input includes dragging a visual object of the displayed information.

8. The system of claim 1, wherein the processor is further configured determine an indication of the touch input.

9. The system of claim 8, wherein determining the indication includes determining a direction of the touch input.

10. The system of claim 8, wherein determining the indication includes determining a distance of the touch input.

11. The system of claim 8, wherein determining the indication includes determining a distance of the touch input in one axis of dimension.

12. The system of claim 1, wherein the first direction is substantially opposite the second direction.

13. The system of claim 1, wherein the touch input indicates the first direction if a touch input instrument has been in contact with the touch input surface for at least a threshold distance from an initial location the touch input instrument contacted the touch input surface.

14. The system of claim 1, wherein the touch input indicates the first direction if a touch input instrument has been in contact with the touch input surface for at least a threshold distance from an initial location the touch input instrument contacted the touch input surface and the touch input instrument is released from the touch input surface at or past the threshold distance from the initial location the touch input instrument contacted the touch input surface.

15. The system of claim 1, wherein the display is further configure to, in the event a touch input instrument has been in contact with the touch input surface for at least a threshold distance in the first direction from an initial location the touch input instrument contacted the touch input surface but before the touch input instrument is released or moved below the threshold distance, is display a visual identification that the pending transaction is indicated as approved if the touch input instrument is released from a current location.

16. The system of claim 1, wherein the display is further configure to, in the event a touch input instrument has been in contact with the touch input surface for at least a threshold distance in the first direction from an initial location the touch input instrument contacted the touch input surface but before the touch input instrument is released, display a visual identification that a current position of the touch input instrument relative to the initial location is associated approving the pending transaction.

17. The system of claim 1, wherein cancelling the pending transaction includes rejecting the pending transaction.

18. The system of claim 1, wherein authorizing the pending transaction includes providing an approval indication that an indicated amount can be deducted from a financial account.

19. A method for processing a touch input, comprising:
displaying on a display screen information about a pending transaction;
receiving a touch input responsive to the displayed information;
in the event the touch input indicates a first direction, authorizing the pending transaction; and
in the event the touch input indicates a second direction, canceling the pending transaction.

20. A computer program product for processing a touch input, the computer program product being embodied in a tangible computer readable storage medium and comprising computer instructions for:
displaying information about a pending transaction;
receiving a touch input responsive to the displayed information;
in the event the touch input indicates a first direction, authorizing the financial transaction; and
in the event the touch input indicates a second direction, canceling the financial is transaction.
